(19) United States
(12) Patent Application Publication
(10) Pub. No.: US 2008/0233855 A1
(43) Pub. Date: Sep. 25, 2008

(54) Ventilating Cross-Member and Method for Making a Ventilating Cross-Member

(75) Inventors: Ivan Baudouin, Aulnay sous Bois (FR); Christian Brancheriau, Herblay (FR); Albin Descamps, Gisors (FR); Thierry Devoulon, La Garenne Colombes (FR); Pascal Rumigny, Lyderic (FR)

Correspondence Address: YOUNG & THOMPSON, 209 Madison Street, Suite 500, ALEXANDRIA, VA, 22314, US

(73) Assignee: FAURECIA INTERIEUR INDUSTRIE, NANTERRE (FR)

(21) Appl. No.: 12/065,609

(22) PCT Filed: Sep. 6, 2006
(86) PCT No.: PCT/FR2006/002053

§ 371 Date: May 13, 2008

(30) Foreign Application Priority Data
Sep. 6, 2005 (FR) 0509092
Nov. 23, 2005 (FR) 0511865

(51) Int. Cl. B60H 1/26; B21D 39/00

(52) U.S. Cl. 454/143; 29/428

(57) ABSTRACT

The invention concerns a ventilating cross-member, and more precisely it concerns a method for making a ventilating cross-member comprising a metal beam (10) and a duct (16) designed to connect two openings (12, 14) between which it follows a winding path. The method includes making a beam (10) which delimits an enclosing volume for receiving the duct between the two openings (12, 14), making the duct (16) which is specifically reversibly deformable between a working state and a retracted inserting state, placing the duct (16) in its inserting state, inserting the duct (16) in the beam (10) through an opening (12, 14) thereof, and placing the duct (16) in its working state. The invention is applicable to motor vehicles.

The present invention relates to a duct for a ventilating cross-member for a motor vehicle, and to a method for producing a ventilating cross-member.

The front part of the passenger compartment of a motor vehicle more often than not comprises a cockpit formed by a cross-member and a dashboard. The cross-member has a mechanical function since it provides the rigidity of the vehicle body. However, it is also desirable that it should fulfil other functions, especially that of guiding the conditioned air to the passenger compartment.

It is known that it is not desirable to circulate the conditioned air directly in a metal beam of a cross-member because the metal constituting the cross-member, or at least part thereof, is a good conductor of heat and therefore causes a considerable loss of heat from the conditioned air. Ducts are therefore generally associated with a metal cross-member to form a so-called “ventilating” cross-member which comprises, in at least one channel formed by a metal profile of the ventilating cross-member, a duct made generally of a plastics material, which is a poor conductor of heat.

Thus, document EP-662 901 describes a dashboard having a cross-member whose lateral parts are formed by two straight tube sections of rectangular cross-section. Close to its outer end, each tube section has a lateral opening. A duct of flexible plastics material is placed in each tube section, between the lateral opening thereof and its central end. A bellows permits axial displacement of the inner end of the duct so that it can be connected to a joining piece of an air conditioning unit. Accordingly, the part of the duct located inside the cross-member has a lateral outlet and forms a curved but not sinuous path. Insertion of the duct into its section of cross-member is effected by limited compression of a single projection at one end of the duct. During and after its insertion, the volume of the part of the duct introduced into the tube section is practically still congruent with that of the tube section.

Since the metal beam of the ventilating cross-member has substantially a mechanical function, it must have various properties which are not particularly well suited to the accommodation of a duct. Thus, when the metal beam has undergone all the necessary welding operations, the duct has to occupy a very sinuous space, so that it is difficult or impossible to fit the duct.

Of course, when designing the metal beam, attempts are made to make as much space available as possible for such ducts. However, ducts frequently have to be incorporated into volumes in which they follow sinuous paths, that is to say into volumes which have a series of bends in different directions. In order that the passage cross-section of the duct is not too restricted, it is desirable for the duct to occupy the greater part of the volume delimited within the beam.

If the duct is rigid, it is not possible to insert it into the beam because of its sinuous shape and the considerable volume it occupies inside the beam.

One solution conventionally employed comprises forming the duct in several parts, for example a practically straight central part and two end parts which are fitted onto or otherwise fixed to the central part. Such a solution is evidently expensive because it requires the handling of several components and specific fitting operations.

Another possibility comprises the freeing of large openings in the metal beam for the insertion of the duct. However, this solution has the disadvantage of reducing the mechanical strength of the metal beam and therefore cannot generally be envisaged.

Another solution which might be envisaged is that of not closing the channel delimited by the metal beam until the duct has been put in position. However, since that positioning is carried out before the final operations of welding the beam, which release a considerable amount of heat, the duct is damaged. That solution is therefore not used in practice.

Another solution which might be envisaged is that of using a very flexible duct which is deformable and can readily be introduced by folding. However, such a solution has the disadvantage that the duct must be fixed to the beam, in particular in the region of the openings, either by adhesive bonding or by fitting in specific devices, and the central part of the duct is then not held and may create noise by vibration and impact against the cross-member.

The object of the invention is, therefore, to produce a ventilating cross-member in which ducts of sinuous form occupy at least the greater part of the volume delimited by the beam, but without the ducts being so flexible that they require the addition of connecting devices or additional fixing operations which might increase the cost of the cross-member.

To that end, the invention relates to ducts having specific deformability properties such that they retain sufficient rigidity to maintain themselves in the space of the metal beam while providing a large passage cross-section.

According to the invention, a duct can assume a working state, in which it occupies a volume that is practically congruent with the volume delimited within the metal beam, and an insertion state, in which its volume and/or sinuosity are reduced so that the duct can easily be inserted into the beam.

More precisely, the invention relates to a ventilating cross-member duct which, in a working state, is to occupy a space envelope which is delimited in a metal beam between at least two openings and has a longitudinal axis between the openings, the longitudinal axis following a sinuous path and the space envelope practically being accessible only through the openings. According to the invention, the duct comprises a device for reversible deformation between the working state, in which the duct has a volume that is practically congruent with the space envelope, and an insertion state, in which the envelope of the volume of the duct has a volume smaller than that of the space envelope.

In an embodiment, in the insertion state, the envelope of the volume of the duct has a volume smaller than that of the space envelope because the cross-section of the duct is smaller than a corresponding cross-section of the duct in its working state.

In a variant, the device for reversible deformation of the duct is a device for contracting the duct on itself so that its cross-section is smaller than its corresponding cross-section in the working state. For example, the device for reversible deformation comprises lines for folding longitudinally at least one wall of the duct.

In that embodiment, it is advantageous for the duct to be equipped with a device for temporarily maintaining it in its insertion state. For example, the device for maintaining the duct in its insertion state is selected from a vacuum application bag and a wire tie.

In the first embodiment, the duct preferably has a third free state in which its volume is greater than a volume congruent with the space envelope, so that, in its working state, the duct is compressed into the space envelope delimited by the beam of a ventilating cross-member.

In another embodiment, in the insertion state, the envelope of the volume of the duct has a volume smaller than that of the space envelope because the sinuosity of the duct is less than that of the duct in its working state. In an example, it comprises at least one part that is articulated in the region of a change of direction of the axis of extension.

The duct preferably also comprises a device for maintaining the duct in the deployed state.

The duct preferably comprises, at one end, a device for attaching a pulling device.

The invention relates also to a method for producing a ventilating cross-member which comprises a metal beam, at least part of which forms a profile delimiting a channel, and at least one duct which is made of a material that is a poor conductor of heat and is to connect two openings between which the duct follows a path having a sinuous longitudinal axis between the openings while being held on the beam so that it is not able to move relative thereto under the effect of vibrations, the method being of the type which comprises the manufacture of a beam which delimits a continuous space envelope for accommodating the duct between the two openings, whose axes are not in alignment. According to the invention, the method further comprises:
producing the duct so that it is reversibly deformable between at least one working state, in which the outside volume of at least part of the duct is congruent with said space envelope between the two openings, and an insertion state, in which the envelope of the outside volume of the duct has a cross-section transverse to the axis of extension that is smaller than that of the space envelope,
bringing the duct into its insertion state,
inserting the duct into the beam through an opening therein, and
bringing the duct into its working state.

In a mode of execution, the method comprises, before the duct is inserted into the beam, the application of a device for maintaining the duct in its insertion state, and the operation of bringing the duct into its working state comprises the removal of the maintaining device. In a variant, the duct is brought into and maintained in its insertion state by the application of a low pressure to the duct. For example, the application of a low pressure to the duct is effected by disposing the duct in a bag and creating a vacuum in the bag.

The insertion operation is preferably carried out by introducing a pulling device into the beam through one opening and then the other, by fixing one end of the duct to the pulling device, and by withdrawing the pulling device, which inserts the duct into the beam.

Other characteristics and advantages of the invention will be better understood upon reading the following description of embodiments, which is given with reference to the accompanying drawing, in which:

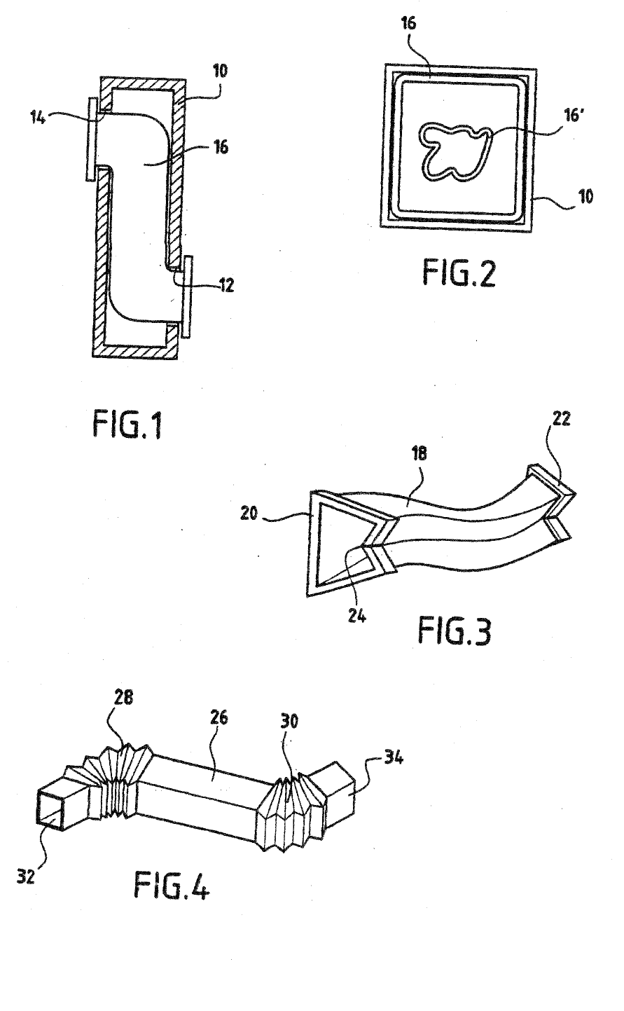

FIG. 1 is a section of part of a ventilating cross-member, showing a metal beam and a duct;

FIG. 2 is a transverse section of the device of FIG. 1, showing the duct in two different states;

FIG. 3 is a perspective view showing another mode of execution of the method of the invention and another embodiment of the duct;

FIG. 4 shows another embodiment of a duct;

FIG. 5 is a perspective view of a variant of a device of the type shown in FIG. 3;

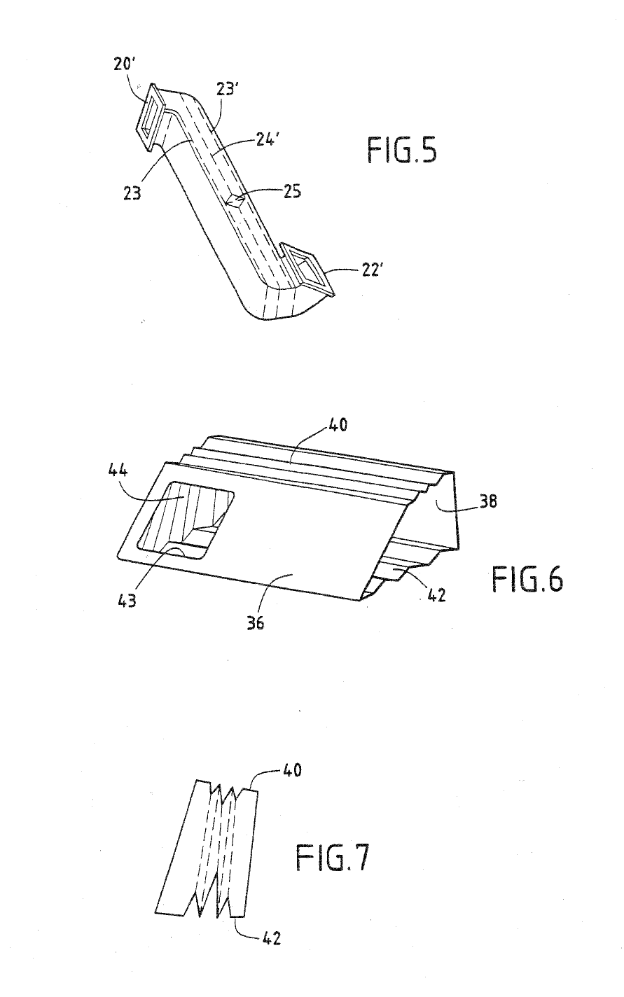

FIG. 6 is a perspective view, partially cut away, of another embodiment; and

FIG. 7 is a diagrammatic section of the device of FIG. 6 in folded form.

FIG. 1 shows, in section, a section of a ventilating cross-member having a metal beam 10 which delimits an elongated channel part Two openings 12, 14 formed on the sides of the metal beam 10 are provided for the passage of a duct 16. As will be seen by simply looking at FIG. 1, if the duct 16 is rigid it cannot be inserted into the beam 10 through an opening because of its sinuous form and the large volume that it occupies inside the beam 10.

According to the invention, the duct is made of a material that is sufficiently rigid that, when it is in place, it retains its shape and position by itself, without the necessity for specific connecting operations, while having sufficient deformability to be inserted into the channel of the metal beam 10 through one of the openings, as far as the other opening.

FIGS. 1 and 2 show a first embodiment, in which the duct is made of a material that has good shape-memory properties but is deformable under the action of sufficient forces.

For example, in an embodiment, the duct 16 is formed of an elastomer which, in its working state, has a volume congruent with that of the part of the channel of the metal beam 10 that it occupies therein. However, in a deformed state 16′ shown in FIG. 2, the cross-section of the duct can be reduced considerably.

Although an elastomer has been mentioned for forming the duct, it is possible to use other materials, especially materials having shape-memory properties. Mention may be made of thermoplastic foams, such as polyolefin foams, especially polyethylene foams, and open-cell foams, for example of polyurethane, rendered tight by means of a film.

The above-mentioned configuration of reduced cross-section can be obtained by disposing the entire duct in a bag of flexible plastics material and creating a vacuum in the bag. In that manner, the duct is compressed and can then easily be introduced through the opening 12 or 14 as far as the opening 14 or 12. One end of the bag is then cut and the bag is withdrawn by the other end, so that the duct 16 automatically assumes its position in the metal beam 10.

In another variant of the method, the duct is contracted on itself in a specific tool and is maintained in the contracted state by a retaining wire forming loops around a longitudinal wire. When the longitudinal wire is withdrawn, the loops free the duct, which automatically regains its shape and is positioned inside the metal beam owing to its shape-memory properties.

The installation of the duct in the beam 10, especially when the duct is of considerable length, can be facilitated by a pulling tool or device which is introduced through one of the openings 12, 14 as far as the other opening, one end of the duct then being attached to the pulling tool, which introduces the duct as far as the other opening, before the maintaining device is removed.

FIG. 3 shows a second embodiment of the duct 18. In this embodiment, the cross-section of the duct 18 is substantially rectangular, and the material of the duct has been weakened in the region of a fold line 24 which follows the entire length of the duct 18, between two end plates 20, 22. In the region of the fold line 24, each plate has preferably been made thinner to facilitate folding.

Although only one fold line has been shown on only one side, it is evidently preferable for the duct to have a plurality of fold lines in order to permit a greater reduction in volume and easier insertion.

As in the embodiment of FIGS. 1 and 2, the duct 18 can be held in its contracted state by the application of a vacuum or by a temporary maintaining device.

FIG. 4 shows another embodiment of a duct 26, in which the duct is deformed by reducing its sinuosity. More precisely, the duct comprises, in the parts corresponding to the greatest changes in direction of the axis of the duct, deformable portions 28, 30, which are shown in the form of bellows. Those portions 28, 30 permit better alignment, on insertion, of the two end portions 32, 34 which are to be located in the openings. In that case, a device for maintaining the duct in the deformed state may be unnecessary when the bellows 28 and 30 have sufficient flexibility.

The embodiment of FIG. 5 is a variant of that of FIG. 3, and analogous reference numerals have been used to denote the end plates 20′ and 22′ and the fold line 24′ formed over the length of the duct.

In that embodiment, there is disposed between the fold lines 23, which surround the fold line 24′, a folding reinforcement 25. More precisely, when the duct has to be folded, the folded transverse reinforcement 25 is pushed with the fold and assumes the shape of the adjacent portion of the duct. Further pushing causes folding of the duct, which collapses in on itself.

When the duct has subsequently been unfolded, the small triangular flanges which delimit the reinforcement 25 naturally assume an outwardly deployed shape, while the main fold 24′ remains folded slightly inwards. The reinforcement 25 and the adjacent portion of the duct, by their opposite orientations, form a structure which withstands crushing of the duct. The reinforcement 25 thus constitutes a device for maintaining the duct in the deployed state.

This modification can be applied to any device in which a fold line separates two extensive surfaces.

FIGS. 6 and 7 show another embodiment, in which a duct has folds which are disposed in the direction of its length, as in the embodiment of FIG. 3, but which form an accordion-like fold as shown in FIG. 4.

More precisely, folded joining walls 40 and 42 are disposed between two flat walls 36 and 38. At one end at least, a bottom folded wall 44 closes off the duct. An opening 43 in the wall 36 forms an inlet or outlet of the duct. The other end is not shown because the representation of the duct is cut away in order to show its deployed cross-section clearly.

As is also shown in FIG. 7, which shows the device of FIG. 6 in folded form, each of the folded walls 40, 42 comprises a fold having three inside edges. The folds of the wall 42 are larger than those of the wall 40 so that, in this embodiment, in the deployed state, the duct is wider in its lower portion than in its upper portion.

The number of fold edges is preferably the same in both the folded walls 40 and 42, so that the wall 44 can easily be folded in order to provide the continuity of the walls 40 and 42.

Although only certain particular embodiments have been shown, the invention is applicable generally to ducts which, by contraction or by a different type of deformation, can be brought to a smaller volume than that corresponding to the congruent accommodation volume in the metal beam of the ventilating cross-member, and which are able to return to the working volume. It will be noted that, depending on the particular circumstances, it is possible to act on the local thickness of the material of the duct in order to promote locally the deformation of the duct as a function of the particular shape of the accommodation volume in the ventilating cross-member 10.

1. Ventilating cross-member duct which, in a working state, is to occupy a space envelope which is delimited in a metal beam (10) between at least two openings (12, 14) and has a longitudinal axis between the openings, the longitudinal axis following a sinuous path and the space envelope practically being accessible only through the openings (12, 14), characterised in that it comprises a device for reversible deformation between the working state, in which the duct (16, 18, 26) has a volume practically congruent with the space envelope, and an insertion state, in which the envelope of the volume of the duct (16, 18, 26) has a volume smaller than that of the space envelope.

2. Duct according to claim 1, characterised in that, in the insertion state, the envelope of the volume of the duct (16, 18) has a volume smaller than that of the space envelope because the cross-section of the duct (16, 18) is smaller than a corresponding cross-section of the duct in its working state.

3. Duct according to claim 1, characterised in that the device for reversible deformation of the duct is a device for contracting the duct (16, 18) on itself so that its cross-section is smaller than its corresponding cross-section in its working state.

4. Duct according to claim 3, characterised in that the device for reversible deformation comprises lines (24) for longitudinally folding at least one wall of the duct (18).

5. Duct according to claim 2, characterised in that the duct (16, 18) is equipped with a device for temporarily maintaining it in its insertion state.

6. Duct according to claim 1, characterised in that, in the insertion state, the envelope of the volume of the duct (26) has a volume smaller than that of the space envelope because the sinuosity of the duct (26) is less than that of the duct in its working state.

7. Duct according to claim 6, characterised in that it comprises at least one articulated part (28, 30) in the region of a change of direction of the axis of extension.

8. Method of producing a ventilating cross-member which comprises a metal beam (10), at least part of which forms a profile delimiting a channel, and at least one duct (16, 18, 26) according to claim 1, which duct is made of a material that is a poor conductor of heat and is to connect two openings (12, 14) between which the duct (16, 18, 26) follows a path having a sinuous longitudinal axis between the openings while being held on the beam (10) so that it is not able to move relative thereto under the effect of vibrations, the method being of the type which comprises the manufacture of a beam (10) which delimits a continuous space envelope for accommodating the duct between the two openings (12, 14), whose axes are not in alignment,
characterised in that it comprises:
producing a duct (16, 18, 26) which is reversibly deformable between at least one working state, in which the outside volume of at least part of the duct is congruent with said space envelope between the two openings, and an insertion state, in which the envelope of the outside volume of the duct (16, 18, 26) has a cross-section transverse to the axis of extension that is smaller than that of the space envelope,
bringing the duct (16, 18, 26) into its insertion state,
inserting the duct (16, 18, 26) into the beam (10) through an opening (12, 14) therein,
bringing the duct (16, 18, 26) into its working state.

9. Method according to claim 8, characterised in that it comprises, before the duct (16, 18, 26) is inserted into the beam (10), the application of a device for maintaining the duct in its insertion state, and in that the operation of bringing the duct (16, 18, 26) into its working state comprises the removal of the maintaining device.

10. Method according to claim 8, characterised in that the insertion step is carried out by introducing a pulling device into the beam (10) through one opening and then the other, by fixing one end of the duct (16, 18, 26) to the pulling device, and by withdrawing the pulling device, which inserts the duct (16, 18, 26) into the beam (10).

11. Method according to claim 9, characterised in that the insertion step is carried out by introducing a pulling device into the beam (10) through one opening and then the other, by fixing one end of the duct (16, 18, 26) to the pulling device, and by withdrawing the pulling device, which inserts the duct (16, 18, 26) into the beam (10).

12. Duct according to claim 2, characterised in that the device for reversible deformation of the duct is a device for contracting the duct (16, 18) on itself so that its cross-section is smaller than its corresponding cross-section in its working state.

13. Duct according to claim 3, characterised in that the duct (16, 18) is equipped with a device for temporarily maintaining it in its insertion state.

14. Duct according to claim 4, characterised in that the duct (16, 18) is equipped with a device for temporarily maintaining it in its insertion state.

15. Method of producing a ventilating cross-member which comprises a metal beam (10), at least part of which forms a profile delimiting a channel, and at least one duct (16, 18, 26) according to claim 2, which duct is made of a material that is a poor conductor of heat and is to connect two openings (12, 14) between which the duct (16, 18, 26) follows a path having a sinuous longitudinal axis between the openings while being held on the beam (10) so that it is not able to move relative thereto under the effect of vibrations, the method being of the type which comprises the manufacture of a beam (10) which delimits a continuous space envelope for accommodating the duct between the two openings (12, 14), whose axes are not in alignment,
characterised in that it comprises:
producing a duct (16, 18, 26) which is reversibly deformable between at least one working state, in which the outside volume of at least part of the duct is congruent with said space envelope between the two openings, and an insertion state, in which the envelope of the outside volume of the duct (16, 18, 26) has a cross-section transverse to the axis of extension that is smaller than that of the space envelope,
bringing the duct (16, 18, 26) into its insertion state,
inserting the duct (16, 18, 26) into the beam (10) through an opening (12, 14) therein,
bringing the duct (16, 18, 26) into its working state.
